(19) United States
(12) Patent Application Publication
(10) Pub. No.: US 2014/0279220 A1
(43) Pub. Date: Sep. 18, 2014

(54) SYSTEMS AND METHODS FOR MOBILE RETAIL ENVIRONMENT

(71) Applicants: Eric Weiner, Cranston, RI (US); Stephen Cross, North Providence, RI (US)

(72) Inventors: Eric Weiner, Cranston, RI (US); Stephen Cross, North Providence, RI (US)

(21) Appl. No.: 14/208,387

(22) Filed: Mar. 13, 2014

Related U.S. Application Data
(60) Provisional application No. 61/781,768, filed on Mar. 14, 2013.
(60) Provisional application No. 61/887,043, filed on Oct. 4, 2013.

(51) Int. Cl. G06Q 30/06

(52) U.S. Cl. CPC G06Q 30/0639
USPC 705/26.9

(57) ABSTRACT

A computer-implemented method of providing customers a vendor's location and service hours is disclosed. The method includes collecting a number of vendors' information, including the vendors' locations. The vendors' locations are translated into latitude and longitude coordinates. The vendors' information and coordinates are stored in a database. A visitor is presented with a search box. The visitor's location is calculated and presented as a default address. A search is conducted in the database for vendors based on search criteria provided by the visitor.

### CROSS-REFERENCE TO RELATED APPLICATION

This patent document claims priority to earlier filed U.S. Provisional patent application Ser. No. 61/781,768, filed Mar. 14, 2013, and U.S. Provisional Patent Application Ser. No. 61/887,043, filed Oct. 4, 2013, the entire contents of which are incorporated by reference.

### BACKGROUND OF THE INVENTION

1. Technical Field

The present patent document relates generally to geo-location and tracking systems more particularly to a method and system of geo-location, tracking and check-in services for food trucks.

2. Background of the Related Art

Food trucks are popular food service establishments, serving patrons at all hours and in locations where bricks and mortars restaurants may not be available or open. They, frequently, serve economical and speedy meals for consumers that are on the go and need a quick meal, to remote construction sites, where the only other choice of a meal is the boxed lunch. Food trucks also serve food at busy street corners, special events, festivals, semi-private events and private events. Food trucks have also expanded into serving upscale cuisine too.

Food truck operators often learn where the best locations by word of mouth, other anecdotal evidence, or experience. Such reliance, though, does not optimize the food truck operator's income. Furthermore, individuals that are in a new area, may not be aware of what food trucks are nearby or the variety of dining options that might be within blocks of them. Some individuals may have a favorite food truck and desire to know how they can find it, regardless of the need to travel. Also, consumers would like to know where their friends are dining and if it is feasible to join them, but food trucks, being mobile, may leave prior to the consumer being able to travel to the food truck.

Therefore, there is a perceived need in the industry for a method and system of consumer's ability to find food trucks and optimizing where food trucks are deployed to maximize profit. There is a further perceived need in the industry for the ability of consumers and food trucks to be able to share their location and time available at the current location so that friends may meet and food trucks attract consumers, that might otherwise think they do not have enough time to reach the food truck before it leaves.

### SUMMARY OF THE INVENTION

The present invention solves the problems of the prior art by providing a method and system for geo-locating, tracking food trucks and also provides check-in services for customers as well as the food truck itself that further provides a mechanism for patrons and the food truck to also state a time that they will be at the present location.

Furthermore, the system and method described herein provides a mechanism to determine the most desirable locations for food trucks to maximize consumer visits.

### BRIEF DESCRIPTION OF THE DRAWINGS

These and other features, aspects, and advantages of the present invention will become better understood with reference to the following description, appended claims, and accompanying drawings where:

FIG. 1 is a flowchart illustrating adding a vendor to the system;

FIG. 2 is flowchart illustrating a vendor checking into the system;

FIGS. 3 and 4, together, are a flowchart illustrating a visitor searching for nearby vendors and vendors serving now.

### DESCRIPTION OF THE PREFERRED EMBODIMENT

The method and system for mobile retail environment includes a computer-implemented method of providing customers a vendor's location and service hours. The method and system includes collecting a number of vendors' information, including the vendors' locations. The vendors' locations are translated into latitude and longitude coordinates. The vendors' information and coordinates are stored in a database. A visitor is presented with a search box. The visitor's location is calculated and presented as a default address. A search is conducted in the database for vendors based on search criteria provided by the visitor.

It should be understood that the method and system may be implemented on any networked computer hardware, including general purpose computers, specialized computer appliances, and virtual machines. The computer hardware, virtual or physical, generally includes a processor, a program memory, and a data storage. The computer hardware may be networked, wired and wirelessly, to other computer hardware and accessible via other electronic devices, such as smartphones, PDAs and the like. The method and system may be coded in any program language and run on any database platform known in the art. No particular relational database system is required and the system may be implemented using any of a variety of open source or proprietary platforms known in the art, such as Oracle Database, IBM DB2, IBM Informix, MySQL, Microsoft SQL Server, PostgreSQL, Amazon AWS, and the like. The system may generally be interacted with via HTML webpages, which display results queried from the database.

Referring to FIG. 1, first, in order to track and refer guests to a particular food truck, the food truck must be added to the system by the administrator. The administrator collects the relevant information from an online form the food truck vendor completes online. The vendor's state and city are translated into latitude and longitude coordinates for use in the geo-location service. The information collected from the food truck vendor is stored in the database. Once entered, a welcome message is sent to the vendor introducing the service and providing instructions to the vendor on updating the food truck's location and service schedule.

Referring to FIG. 2, food trucks may check-in to a geo-located parking location, such as a street corner, parking lot, or other location accessible by vehicle. In addition to the check-in time, the food truck also may provide a duration that the food truck will be at that location including an end time. Customers seeking food from food trucks may then see how long a particular food truck will at a particular location so they know whether they have sufficient time to patronize it.

Trucks may also predefine a regular schedule (ie. Every Monday at 2 pm at a particular location) and have the system automatically check them in at predetermined times and locations.

Referring to FIGS. 3 and 4, the system further provides a mechanism for customers to check in and checkout of the food truck. So, not only can customers find the location and know how long the a particular food truck will be at a particular location, the customer will also be able to determine if they have friends or acquaintances there and how long they will be there.

The system further collects and analyzes data based on the location of the food truck, sales at that particular location, customer preferences, and time periods to create a predictive model to maximize profits for a food truck. That is, time and location data may be pushed to food trucks in order that they may proceed to the most lucrative locations at specified times for their type/genre/ethnicity of food.

Individuals may further subscribe to a particular food truck in order to receive push notifications of when that particular food truck is nearby or arrives at a specified location. A directory of food trucks is also maintained so that individuals may find their favorite food trucks, food trucks that are nearby or subscribe to food trucks location and time information. It should be noted that the food trucks may pay a subscription fee to be a member of the directory and receive information about individuals interested in purchasing their food items. Individuals may search the directory by name, location, time, and genre/ethnicity.

The method and system may be implemented as a mobile device application, such as a smart phone or tablet computer application, and web portal accessible via the internet as is known in the art. The customer and food truck location may be determined by built-in GPS receiver within the mobile device or by use of interpolation based on known locations, such as fixed cellular telephone towers and wi-fi hot spots.

Furthermore, the system permits payments to be made via a smart phone and app, directly to the food truck vendor. Individuals may store a credit or debit card or link a bank account to the system, which may be debited for making purchases at a food truck that accepts mobile payments.

Therefore, it can be seen that the present method and system solves the problems of the prior art by providing a unique method of geo-locating food trucks and permitting food trucks and consumers to check-in and check-out of locations, that further helps food truck vendors optimize their route and time on station at the most lucrative locations for their particular food truck. The directory further permits consumers to search for their favorite food truck, food trucks that are nearby, or a variety of other search factors. In addition, the method sand system facilitates transactions between consumers and food trucks.

It would be appreciated by those skilled in the art that various changes and modifications can be made to the illustrated embodiments without departing from the spirit of the present invention. All such modifications and changes are intended to be within the scope of the present invention.

What is claimed is:

1. A computer-implemented method of providing customers a vendor's location and service hours, comprising:
collecting a plurality of vendors' information, including location;
translating the vendors' location into latitude and longitude coordinates;
storing the vendors' information and coordinates in a database;
presenting a visitor with a search box;
calculating a visitor's location and displaying the visitor's location as a default address; and
conducting a search in the database for vendors based on search criteria of the visitor.

2. The method of claim 1, wherein the visitor's location is calculated based on a visitor's HTML5 geo-location.

3. The method of claim 2, wherein the visitor's location is translated into latitude and longitude coordinates.

4. The method of claim 1, wherein the step of conducting a search returns results all vendors within twenty-five miles of the visitor and are currently in service.

5. The method of claim 1, wherein the step of conducting a search returns results of all vendors within fifty miles of the visitor.

6. The method of claim 1, wherein the step of collecting vendor information includes collecting at least one of vendor name, vendor type, food type, detailed description of vendor, public contact information, private contact information, website, social media URL, social media handle, city, state, and social media indicator.

7. The method of claim 6, wherein food truck type is determined from one of truck, cart and stand.

8. The method of claim 1, further comprising presenting a vendor with a check-in form.

9. The method of claim 8, further comprising storing the vendor check-in geo-location.

10. The method of claim 8, further comprising storing a duration the vendor expects to stay.

11. The method of claim 10, wherein the duration includes a check-in time and an end time.

12. The method of claim 1, further comprising the step of automatically checking-in a vendor at a particular geo-location.

13. The method of claim 1, wherein the step of providing a search box to a visitor further includes a user-changeable address field.

14. The method of claim 1, further comprising the step of a visitor checking-in to a vendor.

15. The method of claim 14, further comprising the step of a visitor checking-out of a vendor.

16. The method of claim 1, further comprising providing optimal location and sales data to vendors based on visitor behavior.

17. The method of claim 1, further comprising the step of maintaining a subscription to a vendor for a visitor and pushing location and service time information to subscribed visitors.

18. The method of claim 1, further comprising maintaining a friends list for each visitor and notifying a visitor of friends' locations at particular vendors' locations.

19. The method of claim 1, further comprising facilitating a payment to a vendor from a visitor.
